(19) United States
(12) Patent Application Publication
(10) Pub. No.: US 2026/0131826 A1
(43) Pub. Date: May 14, 2026

(54) VEHICULAR CONTROL DEVICE AND VEHICULAR CONTROL METHOD

(71) Applicants: DENSO CORPORATION, Kariya-city (JP); AISIN CORPORATION, Kariya (JP); JTEKT CORPORATION, Kariya-shi (JP); ADVICS CO., LTD., Kariya-city (JP)

(72) Inventor: Kota KAGA, Tokyo (JP)

(21) Appl. No.: 19/434,444

(22) Filed: Dec. 29, 2025

Related U.S. Application Data
(63) Continuation of application No. PCT/JP2024/023934, filed on Jul. 2, 2024.

(30) Foreign Application Priority Data
Jul. 3, 2023 (JP) 2023-109558

(51) Int. Cl. B60W 60/00; B60W 10/04; B60W 10/18; B60W 30/06

(52) U.S. Cl. CPC B60W 60/0013; B60W 10/04; B60W 10/18; B60W 30/06

(57) ABSTRACT

A vehicular control device usable for a vehicle that executes autonomous traveling control is provided. The vehicular control device acquires performance information on performance of the vehicle, determines a range of request value estimated to guarantee specified accuracy, determines a braking/driving force required for traveling planned by the autonomous traveling control, and determines a high controllability device and a low controllability device from among a driving device and a brake device. The vehicular control device determines allocation of the required braking/driving force to the driving device and the brake device, such that: the braking/driving force allocated to the low controllability device is a fixed value within the range of request value. The vehicular control device controls the driving force and the braking force so that the driving force generated from the driving device and the braking force generated from the brake device match the allocated values.

### CROSS-REFERENCE TO RELATED APPLICATIONS

This application is a continuation application of International Patent Application No. PCT/JP 2024/023934 filed on Jul. 2, 2024, which designated the U.S. and claims the benefit of priority from Japanese Patent Application No. 2023-109558 filed in Japan on Jul. 3, 2023. The entire disclosures of all of the above applications are incorporated herein by reference.

### TECHNICAL FIELD

The present disclosure relates to a vehicular control device and a vehicular control method.

### BACKGROUND

There is a technology for reducing discomfort feeling of a vehicle occupant during vehicle traveling control.

### SUMMARY

According to an aspect of the present disclosure, a vehicular control device usable for a vehicle that executes autonomous traveling control is provided. The vehicular control device acquires performance information on performance of the vehicle, determines a range of request value estimated to guarantee specified accuracy, determines a braking/driving force required for traveling planned by the autonomous traveling control, and determines a high controllability device and a low controllability device from among a driving device and a brake device. The vehicular control device determines allocation of the required braking/driving force to the driving device and the brake device, such that: the braking/driving force allocated to the low controllability device is a fixed value within the range of request value. The vehicular control device controls the driving force and the braking force so that the driving force generated from the driving device and the braking force generated from the brake device match the allocated values.

### BRIEF DESCRIPTION OF DRAWINGS

Objects, features, and advantages of the present disclosure will become apparent from the following detailed description made with reference to the accompanying drawings. In the drawings:

FIG. 1 is a diagram showing an example of a schematic configuration of a vehicular system;

FIG. 2 is a diagram showing an example of a schematic configuration of a driver assist ECU 10;

FIG. 3 is a diagram showing an example of a schematic configuration of a braking driving control unit;

FIG. 4 is a diagram for description of an example of a manner of determining a fixed value allocated to a low controllability device by an allocation determination unit;

FIG. 5 is a diagram for description of an example of a flow during autonomous parking;

FIG. 6 is a flowchart showing an example of a flow of control in a driver assist ECU during autonomous parking;

FIG. 7 is a flowchart showing an example of a flow of during-traveling process in a braking driving control unit; and

FIG. 8 is a diagram for description of an example of a change in braking/driving force due to control by the braking driving control unit during traveling.

### DETAILED DESCRIPTION

There is a technology that attempts to reduce discomfort feeling of a vehicle occupant during vehicle traveling control for autonomous parking. In this technology, a braking force increase timing is adjusted according to a remaining distance X from a current position to a target position PT in order to cancel out a driving force fluctuation during the vehicle traveling control. Specifically, if the remaining distance X is equal to a threshold Xth, the braking force increase timing is set at a reference timing T0. If the remaining distance X is greater than the threshold Xth, the braking force increase timing is adjusted to be later than the reference timing T0. If the remaining distance X is less than the threshold Xth, the braking force increase timing is adjusted to be earlier than the reference timing T0.

In the above technology, the attempt is made to cancel out the driving force fluctuation during the traveling by increasing the braking force. However, it does not take into account control accuracy achieved by actuators such as a driving device and a brake device in response to requests. Therefore, this technology may not achieve an expected braking force increase and may not fully cancel out the driving force fluctuation. In other words, there is a concern that the discomfort feeling of a vehicle occupant may not be reduced. In particular, during traveling under the autonomous parking frequently involving in passage through a narrow area, unnecessary approach to surrounding obstacles may happen and the discomfort feeling of an occupant may increase.

It is one object of the present disclosure to provide a vehicular control device and a vehicular control method that can suppress occupant discomfort with respect to traveling control, even when traveling control is autonomously executed during vehicle traveling.

According to a first aspect of the present disclosure, a vehicular control device that is usable for a vehicle that executes autonomous traveling control is provided, The vehicular control device includes:
at least one processor that executes a program and/or at least one dedicated circuit, configured to:
in a braking/driving force control process, control a driving force generated from a driving device of the vehicle and a braking force generated from a brake device of the vehicle;
in a performance information acquisition process, acquire performance information on performance of the vehicle, including:
driving accuracy, which is accuracy achieved by the driving device in response to a force request;
braking accuracy, which is accuracy achieved by the brake device in response to a force request;
a driving force range, which is a range of the driving force that the driving device is able to reflect the force request in with specified accuracy or accuracy higher than the specified accuracy;
a braking force range, which is a range of the braking force that the brake device is able to reflect the force request in with specified accuracy or accuracy higher than the specified accuracy; and
a request minimum value, which is a minimum value of the driving force requestable to the driving device and depends on speed of the vehicle;
in a request range determination process, determine a driving system request range and a brake system request range by using the acquired performance information, wherein the driving system request range is a range of request value estimated to guarantee the specified accuracy of the driving device and the brake system request range is a range of request value estimated to guarantee the specified accuracy of the brake device;
in a required braking/driving force determination process, determine a braking/driving force required for traveling planned by the autonomous traveling control when the vehicle is traveling under the autonomous traveling control, wherein the braking/driving force is at least one of the driving force or the braking force;
in a controllability determination process, determine a high controllability device and a low controllability device from among the driving device and the brake device, wherein the high controllability device is a device that performs control with higher accuracy and the low controllability device is a device that performs control with lower accuracy; and
in an allocation determination process, determine allocation of the braking/driving force determined in the required braking/driving force determination process to the driving device and the brake device to determine values of the braking/driving force allocated to the driving device and the brake device, such that: the braking/driving force allocated to the low controllability device is a fixed value within the range of request value determined in the request range determination process; and, of the braking/driving force determined in the required braking/driving force determination process, a part attained by other than the fixed value is a value within the range of request value for the high controllability device determined in the request range determination process, wherein:
the at least one processor and/or the at least one dedicated circuit is configured to:
in the braking/driving force control process, control the driving force and the braking force when the vehicle is traveling so that the driving force generated from the driving device and the braking force generated from the brake device match the values determined in the allocation determination process.

According to a second aspect of the present disclosure, a vehicular control method executed by at least one processor and usable for a vehicle that executes autonomous traveling control is provided. The vehicular control method includes:
in a braking/driving force control process, controlling a driving force generated from a driving device of the vehicle and a braking force generated from a brake device of the vehicle;
in a performance information acquisition process, acquiring performance information on performance of the vehicle, including:
driving accuracy, which is accuracy achieved by the driving device in response to a force request;
braking accuracy, which is accuracy achieved by the brake device in response to a force request;
a driving force range, which is a range of the driving force that the driving device is able to reflect the force request in with specified accuracy or accuracy higher than the specified accuracy;
a braking force range, which is a range of the braking force that the brake device is able to reflect the force request in with specified accuracy or accuracy higher than the specified accuracy; and
a request minimum value, which is a minimum value of the driving force requestable to the driving device and depends on speed of the vehicle;
in a request range determination process, determining a driving system request range and a brake system request range by using the acquired performance information, wherein the driving system request range is a range of request value estimated to guarantee the specified accuracy of the driving device and the brake system request range is a range of request value estimated to guarantee the specified accuracy of the brake device;
in a required braking/driving force determination process, determining a braking/driving force required for traveling planned by the autonomous traveling control when the vehicle is traveling under the autonomous traveling control, wherein the braking/driving force is at least one of the driving force or the braking force;
in a controllability determination process, determining a high controllability device and a low controllability device from among the driving device and the brake device, wherein the high controllability device is a device that performs control with higher accuracy and the low controllability device is a device that performs control with lower accuracy; and
in an allocation determination process, determining allocation of the determined braking/driving force to the driving device and the brake device to determine values of the braking/driving force allocated to the driving device and the brake device, such that: the braking/driving force allocated to the low controllability device is a fixed value within the range of request value determined in the request range determination process; and, of the braking/driving force determined in the required braking/driving force determination process, a part attained by other than the fixed value is a value within the range of request value for the high controllability device determined in the request range determination process, wherein:
when the vehicle is traveling, the braking/driving force control process controls the driving force and the braking force so that the driving force generated from the driving device and the braking force generated from the brake device match the values determined in the allocation determination process.

According to the above configuration, it is possible to keep the braking/driving force generated from the driving device and the brake device during traveling within the driving system request range and the brake system request range, respectively. Therefore, it is possible to control the braking/driving force with higher request-achieving accuracy and suppress unnecessary acceleration/deceleration. Among the driving device and the brake device, the braking/driving force generated from the low controllability device is fixed while the braking/driving force generated from the high controllability device is variable. Therefore, during traveling, the high controllability device, which executes control with higher accuracy, can preferentially control the braking/driving force during the traveling. Therefore, it is possible to control the braking/driving force with higher accuracy and suppress unnecessary acceleration/deceleration. As a result, it is possible to suppress occupant discomfort with respect to traveling control, even when traveling control is autonomously executed during vehicle traveling.

Embodiments of the present disclosure will be described with reference to the drawings. Like references are used to refer to like parts to omit duplicated description.

### First Embodiment

### <Schematic Configuration of Vehicular System 1>

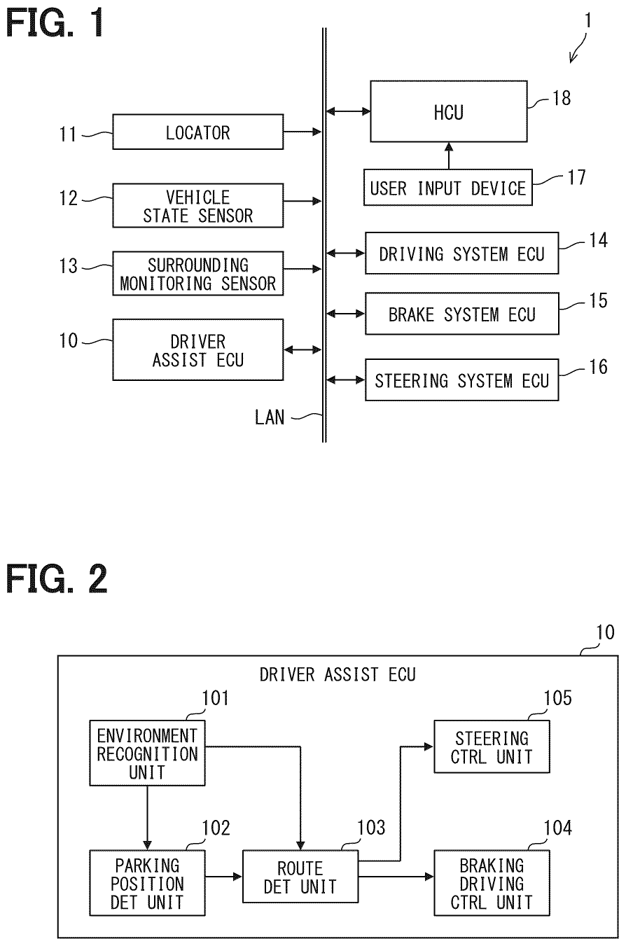

A first embodiment of the present disclosure will be described with reference to the accompanying drawings. The vehicular system 1 shown in FIG. 1 is usable for a vehicle that executes autonomous traveling control. The autonomous traveling control may be also referred to as autonomous driving. As shown in FIG. 1, the vehicular system 1 includes a driver assist ECU 10, a locator 11, a vehicle state sensor 12, a surrounding monitoring sensor 13, a driving system ECU 14, a brake system ECU 15, a steering system ECU 16, a user input device 17, and an HCU (Human Machine Interface Control Unit) 18. For example, the driver assist ECU 10, the locator 11, the vehicle state sensor 12, the surrounding monitoring sensor 13, the driving system ECU 14, the brake system ECU 15, the steering system ECU 16, and the HCU 18 may be connected to an in-vehicle LAN (see FIG. 1 for LAN). Although the vehicle using the vehicular system 1 is not necessarily limited to an automobile, a case using the automobile will be described by way of example.

The system may have multiple levels of driving automation (hereafter referred to as “automation levels”), as defined by SAE, for example. The automation levels are classified into, for example, LV 0 to LV 5 as follows. The LV 0 is a level where a driver performs all driving tasks without system intervention. The driving tasks may be also referred to as dynamic driving tasks. The driving tasks are, for example, steering, acceleration deceleration, and surrounding monitoring. The LV 0 corresponds to so-called manual driving. The LV 1 is a level where a system assists either the steering or the acceleration deceleration. The LV 1 corresponds to so-called driving assistance. The LV 2 is a level where a system assists both the steering and the acceleration deceleration. The LV 2 corresponds to so-called partial driving automation. The LV1 and LV2 are also considered as part of autonomous driving.

For example, in the autonomous driving LV 1 and LV 2, a driver has a monitoring obligation with respect to safety driving (hereinafter simply referred to as a monitoring obligation). That is, this corresponds to autonomous driving with the monitoring obligation. The monitoring obligation includes visual monitoring of surroundings. The autonomous driving at LV 1 and 2 may be referred to as autonomous driving in which a second task is not permitted. The second task is an act other than driving permitted for the driver, and is a specific act defined in advance. The second task may be referred to as a secondary activity, other activities, or the like. The second task is required not to prevent the driver from responding to a request to take over a driving operation from an autonomous driving system. Supposed examples of the second task include watching contents such as a video, operating a smartphone, and reading a book.

In the autonomous driving L3, the system is able to perform all driving tasks under specific conditions, and the driver performs the driving operation in emergency situations. In the autonomous driving L3, the driver should be able to respond quickly when the system requests to hand over the driving operation. The driving handover can also be rephrased as transfer of the surrounding monitoring obligation from the vehicular system to the driver. The LV 3 corresponds to so-called conditional driving automation. In the autonomous driving LV4, the system is able to perform all the driving tasks except for under specific situations such as an unsupported road, an extreme environment, and the like. The LV 4 corresponds to so-called advanced driving automation. In the autonomous driving L5, the system is able to perform all the driving tasks under all environments. The LV 5 corresponds to a full driving automation.

For example, the autonomous driving at LV 3 or higher is an autonomous driving in which the driver does not have the monitoring obligation. In other words, the autonomous driving at LV 3 to LV 5 corresponds to autonomous driving without the monitoring obligation. The autonomous driving at LV 3 or higher may be also referred to as autonomous driving in which the second task is permitted. The autonomous traveling control of the present embodiment is such that the system performs at least acceleration and deceleration. The autonomous traveling control of the present embodiment may be autonomous driving with or without the monitoring obligation. The autonomous traveling control of the present embodiment is the autonomous driving control for autonomous parking. In the following, the autonomous traveling control of the present embodiment will be described on assumption that the system performs all driving tasks during autonomous parking.

The locator 11 includes a GNSS (Global Navigation Satellite System) receiver and an inertial sensor. The GNSS receiver receives positioning signals from positioning satellites. The inertial sensor includes, for example, a gyro sensor and an acceleration sensor. The locator 11 combines the positioning signals received by the GNSS receiver with a measurement result of the inertial sensor to successively detect the position of the host vehicle (hereinafter, a host vehicle position). Locating the host vehicle may also use a travel distance calculated from the signal successively output from a vehicle speed sensor mounted to the vehicle. The host vehicle position is represented by, for example, a center position of the rear axle of the host vehicle and may be expressed as coordinates in the XY coordinate system with the X-axis and Y-axis on the horizontal plane.

The vehicle state sensor 12 is a group of sensors for detecting various states of the host vehicle. The vehicle state sensor 12 includes a vehicle speed sensor, a steering angle sensor, etc. The vehicle speed sensor detects the speed of the host vehicle. The steering angle sensor detects a steering angle, such as the steering angle or turning angle of the host vehicle. The vehicle state sensor 12 outputs detected sensing information to the in-vehicle LAN. The sensing information detected by the vehicle state sensor 12 may be output to the in-vehicle LAN via an ECU mounted to the host vehicle.

The surrounding monitoring sensor 13 monitors a surrounding environment of the host vehicle. For example, the surrounding monitoring sensor 13 detects an obstacle around the host vehicle, such as a pedestrian, a movable object such as another vehicle, and a stationary object such as a fallen object on the road. Additionally, a road marking such as a lane marking outside host vehicle is detected. The surrounding monitoring sensor 13 is, for example, a surrounding monitoring camera that captures an image of a predetermined range outside the host vehicle, or a probe wave sensor that transmits probe waves to a predetermined range outside the vehicle. Examples of the probe wave sensor include a millimeter wave radar, a sonar, a LIDAR (Light Detection and Ranging/Laser Imaging Detection and Ranging). For example, the predetermined range may be a range at least partially covering the front area, the rear area, the left area, or the right area of the host vehicle. The surrounding monitoring camera outputs the successively captured image to the driver assist ECU 10 as the sensing information. As the sensing information output to the driver assist ECU 10, the probe wave sensor successively outputs a scanning result based on the received signal obtained when the probe wave sensor receives a reflected wave reflected by an obstacle.

The driving system ECU 14 and the brake system ECU 15 are electronic control units that execute acceleration deceleration control. The driving system ECU 14 controls the driving device of the host vehicle. When the vehicle uses an internal combustion engine as a traveling power source, the driving system ECU 14 may be, for example, an engine ECU. When the vehicle uses a motor as the traveling power source, the driving system ECU 14 may be, for example, a power unit control ECU. The traveling power source corresponds to the driving device. The brake system ECU 15 controls the brake device of the vehicle. The brake system ECU 15 may be, for example, a brake ECU. The steering system ECU 16 is an electronic control unit that executes steering control. The steering system ECU 16 controls a steering device of the host vehicle. The steering system ECU 16 may be, for example, a steering ECU. An actuator for steering corresponds to a steering device.

The user input device 17 receives an input from an occupant of the vehicle. The user input device 17 may be an operation device that receives an operation input from an occupant. The operation device may be a mechanical switch, or a touch switch integrated with a display device. The user input device 17 is not limited to the operation device that receives the operation input, as long as it is a device that receives an input from an occupant. For example, the user input device 17 may be a speech input device that receives a command input from the occupant by way of speech. The user input device 17 includes an auto-parking activation switch (“AP switch”). The AP switch is a switch for activating an autonomous parking function of the driver assist ECU 10.

The HCU 18 includes, as its main component, a computer including a processor, a volatile memory, a nonvolatile memory, I/O, and a bus connecting these. The HCU 18 executes various processes related to interaction between an occupant and a system of the host vehicle by executing a control program stored in the nonvolatile memory. The HCU 18 acquires information on the input received from the occupant at the user input device 17.

The driver assist ECU 10 includes, as its main component, a computer including, for example, a processor, a volatile memory, a nonvolatile memory, I/O, and a bus connecting these. The driver assist ECU 10 executes processes related to the autonomous parking by executing a control program stored in the nonvolatile memory. The configuration of the driver assist ECU 10 will be described in detail below.

### <Schematic Configuration of Driver Assist ECU 10>

The schematic configuration of the driver assist ECU 10 will be described using FIG. 2. As shown in FIG. 2, the driver assist ECU 10 includes an environment recognition unit 101, a parking position determination unit 102, a route determination unit 103, a braking driving control unit 104, and a steering control unit 105 as functional blocks. Part or all of the functions performed by the driver assist ECU 10 may be configured by a hardware component such as one or more ICs. Alternatively, part or all of the functional blocks of the driver assist ECU 10 may be provided by a processor executing software in combination with a hardware component.

The environment recognition unit 101 recognizes a traveling environment of the host vehicle from the sensing information acquired from the surrounding monitoring sensor 13. By using the sensing information from the surrounding monitoring sensor 13, the environment recognition unit 101 recognizes the position, shape, and movement state of an object around the host vehicle and generates a virtual space reproducing the actual traveling environment. The environment recognition unit 101 may also recognize the position of the lane marking around the host vehicle. The environment recognition unit 101 detects a parking space from the recognized traveling environment. The parking space is an open space where the host vehicle is able to be parked. Whether or not the space is open may be determined by the environment recognition unit 101 based on the size of the host vehicle. As an example, the environment recognition unit 101 may detect that an open space between obstacles or adjacent to an obstacle is the parking space. The environment recognition unit 101 may also detect an open space between car park line markings as the parking space.

The parking position determination unit 102 determines a target parking position for parking the vehicle in the parking space detected by the environment recognition unit 101. The target parking position may be determined so that the host vehicle fits into the parking space. The parking position determination unit 102 may determine the parking space according to the input received at the user input device 17. In other words, the parking space selected by the occupant from among candidate parking spaces may be determined as the parking space.

The route determination unit 103 determines a target path (also called a route) that the host vehicle is to follow to the target parking position determined by the parking position determination unit 102 while avoiding contact with obstacles. The route determination unit 103 may successively re-determine the target path to adapt to changing situations.

The braking driving control unit 104 determines a target vehicle speed and a target acceleration to move the host vehicle along the route determined by the route determination unit 103. For example, the target vehicle speed after starting the host vehicle may be a fixed speed. This determined target vehicle speed and target acceleration correspond to a requested behavior of the host vehicle for the traveling planned by the autonomous traveling control. The braking driving control unit 104 determines a braking/driving force for attaining the determined target vehicle speed and target acceleration. The braking/driving force may be referred to as brake driving power. The braking/driving force is a collective term for such forces as the braking force and the driving force. The braking force may be referred to as braking power. The driving force may be referred to as driving power. The braking/driving force refers to at least one of the braking force or the driving force. The braking force and the driving force may be expressed, for example, in units of N (newton). The braking force is a negative value, and the driving force is a positive value. The braking driving control unit 104 commands the driving system ECU 14 and the brake system ECU 15 to generate the determined braking/driving force. Because of this, the driving force generated from the traveling drive source and the braking force generated from the brake device are controlled. The braking driving control unit 104 determines and controls the braking/driving force for starting the host vehicle from a stopped state. The braking driving control unit 104 determines and controls the braking/driving force during traveling after starting the vehicle. The braking driving control unit 104 determines and controls the braking/driving force for stopping the vehicle. A process in the braking driving control unit 104 during traveling after starting the vehicle will be described in detail below. The process during traveling after starting the vehicle is hereinafter referred to also as “during-travelling process.”

The steering control unit 105 determines a target steering angle for the host vehicle to move along the route determined by the route determination unit 103. The target steering angle is uniquely determined from a curvature of the route at a target point. A relationship between the curvature of the path and the target steering angle derived in advance by testing or other means may be used. The steering control unit 105 commands the steering system ECU 16 to attain the determined target steering angle. Because of this, the actuator for steering is controlled and the steering angle of the host vehicle is autonomously changed.

### <Schematic Configuration of the Braking Driving Control Unit 104>

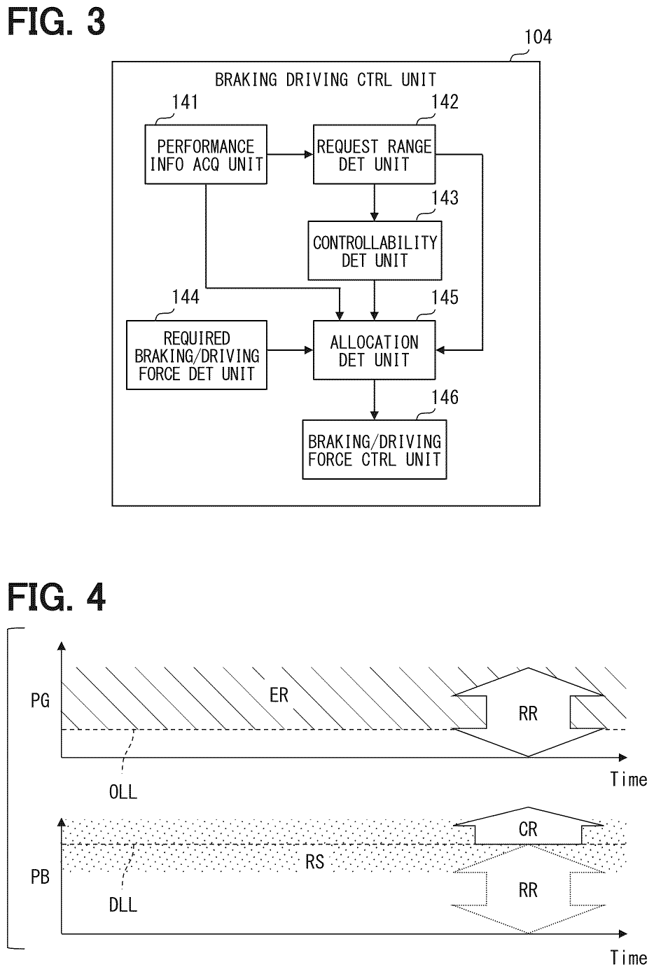

A schematic configuration of the braking driving control unit 104 relating to the during-traveling process will be described using FIG. 3 With respect to the during-traveling process, the braking driving control unit 104 includes a performance information acquisition unit 141, a request range determination unit 142, a controllability determination unit 143, a required braking/driving force determination unit 144, an allocation determination unit 145, and a braking/driving force control unit 146 as functional blocks, as shown in FIG. 3. The braking driving control unit 104 corresponds to a vehicular control device. Execution of processing of each functional block of the braking driving control unit 104 by a computer corresponds to execution of a vehicular control method.

The performance information acquisition unit 141 acquires performance information on performance of the host vehicle. The performance information may be information on performance of an actuator such as the brake device and the driving device of the host vehicle. The brake device and the driving device are collectively referred to as the actuator. The performance information acquisition unit 141 may acquire the performance information prestored in the non-volatile memory of the driver assist ECU 10. In an alternative configuration, the performance information may be stored in a non-volatile memory other than that of the driver assist ECU 10. The performance information includes driving accuracy, braking accuracy, a driving force range, a braking force range, and a request minimum value. This process in the performance information acquisition unit 141 corresponds to a performance information acquisition process. The performance information may include information other than that described above. The performance information may include a driving force speed and a braking force speed.

The driving accuracy is accuracy achieved by the driving device in response to a force request. Specifically, the driving accuracy is a range of error of the force actually generated from the driving device in response to the force request. This force request may be a request for the driving force. The braking accuracy is accuracy achieved by the brake device in response to the force request. Specifically, the braking accuracy is a range of error of the force actually generated from the brake device in response to the force request. This force request may be a request for the braking force. The request minimum value is a minimum value of the driving force requestable to the driving device and depends on the speed of the host vehicle. The request minimum value may be, for example, information mapping between the minimum value of the driving force and the speed. The driving force speed is the driving force that the driving device is able to change per unit time. The braking force speed is the braking force that the brake device is able to change per unit time. The driving force speed and the braking force speed may be expressed in units of N/sec, for example.

The driving force range is a range of the driving force that the driving device is able to reflect the force request in with specified accuracy or accuracy higher than the specified accuracy. Specifically, the driving force range is the range of the driving force that the driving device is able to accurately reflect the force request in. The specified accuracy may be specifiable into any as appropriate. This force request may be a request for the driving force. It may be preferable that the range of the driving force is a range in which the force request is successfully reflected with specified accuracy or accuracy higher than the specified accuracy in respect of both static and dynamic characteristics. The static characteristic is a range of output variation when the request is a fixed value. The dynamic characteristic is a range of output variation when the request is a variable value. The static and dynamic characteristics may be specified in advance by experiments, simulations, etc. Because of this, the range of the driving force that the driving device is able to reflect the force request in with specified accuracy or accuracy higher than the specified accuracy regardless of whether the request is the fixed value or the variable value is usable as the driving force range. Thus, it is possible to control the driving force with higher accuracy. The braking force range is a range of the braking force that the brake device is able to reflect the force request in with specified accuracy or accuracy higher than the specified accuracy. Specifically, the braking force range is the range of the braking force that the brake device is able to accurately reflect the force request in. This force request may be a request for the braking force. It may be preferable that the braking force range is a range in which the force request is successfully reflected with specified accuracy or accuracy higher than the specified accuracy in respect of both static and dynamic characteristics. Because of this, the range of the braking force that the brake device is able to reflect the force request in with specified accuracy or accuracy higher than the specified accuracy regardless of whether the request is the fixed value or the variable value is usable as the braking force range. Thus, it is possible to control the braking force with higher accuracy.

The request range determination unit 142 determines a driving system request range and a brake system request range. The driving system request range is a range of request value estimated to guarantee specified accuracy of the driving device. The specified accuracy may be, for example, the same as that for the driving force range described above. The brake system request range is a range of request value estimated to guarantee specified accuracy. The specified accuracy may be, for example, the same as that for the braking force range described above. The driving system request range and the brake system request range are collectively referred to hereinafter as a request range. The request range determination unit 142 determines the request range by using the performance information acquired by the performance information acquisition unit 141. Details will be described later. The process in the request range determination unit 142 corresponds to a request range determination process.

The request range determination unit 142 may determine the driving system request range by using the drive accuracy, the driving force range, and the request minimum values acquired by the performance information acquisition unit 141. The range of the driving force that falls within the driving force range even if the error indicated by the driving accuracy occurs and that is larger than or equal to the request minimum value may be determined as the driving system request range by the request range determination unit 142. The request range determination unit 142 may determine the brake system request range by using the braking accuracy and the braking force range acquired by the performance information acquisition unit 141. The range of the braking force that falls within the braking force range even if the error indicated by the braking accuracy occurs may be determined as the brake system request range by the request range determination unit 142.

The controllability determination unit 143 determines a high controllability device and a low controllability device from among the driving device and the brake device. The high controllability device is one of the driving device and the brake device that performs control with higher accuracy than the other. The low controllability device is one of the driving device and the brake device that performs control with lower accuracy than the other. The controllability determination unit 143 may determine the high controllability device and the low controllability device by, for example, comparing the performance information of the driving device and that of the brake device in the same dimensions. Examples of the comparison include comparison between the driving force speed and the braking force speed, comparison between the driving accuracy and the braking accuracy, etc. The process in the controllability determination unit 143 corresponds to a controllability determination process.

The controllability determination unit 143 may determine the high controllability device and the low controllability device by using the driving system request range and the brake system request range determined by the request range determination unit 142. The controllability determination unit 143 may determine that the high controllability device is a device that is wider in the request range determined by the request range determination unit 142. The controllability determination unit 143 may determine that the low controllability device is a device that is narrower in the request range determined by the request range determination unit 142. Specifically, the controllability determination unit 143 may determine the high controllability device and the low controllability device such that: when the driving system request range is wider than the brake system request range, the driving device is the high controllability device and the brake device is the low controllability device; and when the driving system request range is narrower than the brake system request range, the driving device is the low controllability device and the brake device is the high controllability device. According to this, it is possible to determine that the high controllability device is a device able to perform control with higher accuracy, even when the request value for the actuator is a variable value. Therefore, even when the request value is a variable value, it is easy to control the braking/driving force with high accuracy.

The controllability determination unit 143 may determine the high controllability device and the low controllability device in a way other than those described above. For example, the controllability determination unit 143 may determine the high controllability device and the low controllability device based on a result of real-time learning of controllability of the driving device and the brake device. This learning may be done, for example, in the driver assist ECU 10 by using information acquired from the actuator during the traveling.

While the host vehicle is traveling under the autonomous traveling control, the required braking/driving force determination unit 144 determines the braking/driving force being at least one of the driving force or the braking force required for traveling planned by the autonomous traveling control. It may be preferable that the required braking/driving force determination unit144 successively determines the braking/driving force to reduce deviation of the actual behavior from the behavior requested for the traveling planned by the autonomous traveling control. Specifically, the required braking/driving force determination unit 144 may determine the braking/driving force for reducing the deviation between the request value and the actual value, e.g., deviation of the actual vehicle speed from the target vehicle speed. The required braking/driving force determination unit 144 may determine the braking/driving force for reducing deviation of the actual acceleration from the target acceleration. According to this, it is possible to execute feedback to successively fit the actual behavior into the target behavior and facilitate attaining the behavior of the host vehicle conforming to the request. The process in the required braking/driving force determination unit 144 corresponds to a required braking/driving force determination process.

The allocation determination unit 145 determines allocation of the braking/driving force determined by the required braking/driving force determination unit 144 to the driving device and the brake device to determine values of the braking/driving force allocated to the driving device and the brake device This allocation is made in order to attain highly accurate control of the braking/driving force. The allocation determination unit 145 determines that the braking/driving force allocated to the low controllability device is a fixed value within the request range determined by the request range determination unit 142. The allocation determination unit 145 determines that, of the request braking/driving force determined by the required braking/driving force determination unit 144, a part attained by other than the fixed value is a value within the range of the request value for the high controllability device determined by the request range determination unit 142. The process in the allocation determination unit 145 corresponds to an allocation determination process.

According to the above configuration, the braking/driving force generated from the driving device and the brake device during the traveling is able to fall within the driving system request range and the brake system request range, respectively. As an example, let us assume a case where a small driving force is requested but the driving device alone is not able to attain the small driving force with high accuracy. In this case, the small driving force is attained in combination with the braking force of the brake device. In this way, it is possible to increase the driving force generated from the driving device to a value that is controllable by the driving device with high accuracy. Because of this, it is possible for both the driving device and the brake device to control the braking/driving force in a range where highly accurate control is performable. Therefore, it is possible to control the braking/driving force with high accuracy in request achievement and suppress unnecessary acceleration/deceleration. The braking/driving force generated from the low controllability device among the driving device and the brake device is fixed, while the braking/driving force generated from the high controllability device is variable. This makes it possible for the high controllability device able to execute control with higher accuracy to preferentially control the braking/driving force. Therefore, it is possible to control the braking/driving force with higher accuracy and suppress unnecessary acceleration/deceleration. As a result, even when the traveling control is autonomously executed while the vehicle is traveling, it is possible to further suppress occupant discomfort with respect to the traveling control.

It may be preferred that the allocation determination unit 145 determine that a value closest to 0 among values that meet a specific condition is the fixed value for the low controllability device. The specific condition is that each of the values allocated to the low controllability device and the high controllability device is within the range of request value determined by the request range determination unit 142. This makes it possible to reduce traveling energy consumption efficiency such as fuel consumption and electricity consumption. Thus, even when the traveling control is autonomously executed while the vehicle is traveling, it is possible to suppress the discomfort of the occupant with regard to the traveling control while reducing the traveling energy consumption efficiency. The specific condition may further require that any value within an expected change range is able to be attained by a value obtained by adding together the fixed value determined for the low controllability device and the value within the request range for the high controllability device. The expected change range is a range of change in the request value estimated from the traveling planned by the autonomous traveling control. The expected change range may be estimated by the braking driving control unit 104 based on the traveling planned by the autonomous traveling control. This estimation may use a range of use of target acceleration profile, an expected correction amount by the feedback, etc. The range of use of target acceleration profile is a scheduled range of the target acceleration. The expected correction amount by the feedback is a change amount of the braking/driving force expected in the aforementioned feedback. The frequency of successive determination of the braking force by the required braking/driving force determination unit 144 is set so that the expected change range falls within a range that enables the aforementioned condition to be met.

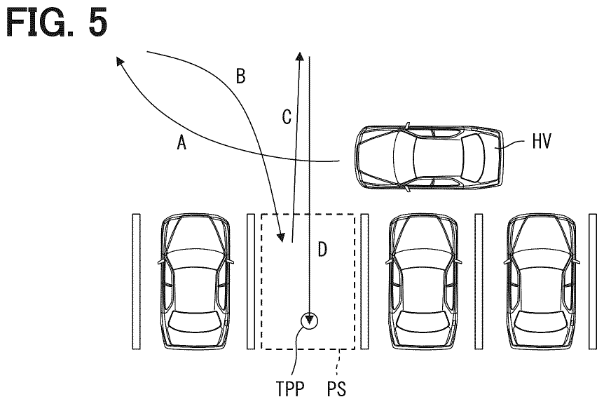

Now, using FIG. 4, an example of determination by the allocation determination unit 145 of the fixed value allocated to the low controllability device will be described. In the graph of FIG. 4, the vertical axis is the braking/driving force, and the horizontal axis is time. In FIG. 4, PG refers to the high controllability device and PB refers to the low controllability device. In FIG. 4, ER refers to the expected change range. In FIG. 4, ORL refers to a lower output limit of the high controllability device. In FIG. 4, RR refers to a required range. The required range is a range obtained by adding together a range from 0 to the lower output limit of the high controllability device and the expected change range. In other words, the required range is a range from 0 to an upper limit of the expected change range. In FIG. 4, RS refers to the request range for the low controllability device. In FIG. 4, CR refers to a configurable range of the low controllability device. The configurable range is a range of the fixed value able to be allocated to the low controllability device. in FIG. 4, DLL refers to the fixed value allocated to the low controllability device. From the required range RR, the allocation determination unit 145 derives the configurable range of the low controllability device. Of a range where the configurable range CR and the request range RS of the low controllability device overlap with each other, a lower limit value closest to 0 is determined as the fixed value allocated to the low controllability device.

The braking/driving force control unit 146 controls the driving force generated from the driving device and the braking force generated from the brake device of the host vehicle. The braking/driving force control unit 146 controls the driving force generated from the driving device by issuing the command to the driving system ECU 14. The braking/driving force control unit 146 controls the braking force generated from the brake device by issuing the command to the brake system ECU 15. During the traveling of the host vehicle, the braking/driving force control unit 146 controls the driving force generated from the driving device and the braking force generated from the brake device so that the driving force and the braking force match the values determined by the allocation determination unit 145. In other words, the values determined by the allocation determination unit 145 are used as the request values for the driving device and the brake device, so that the braking/driving force is controlled. The process in the braking/driving force control unit 146 corresponds to a braking/driving force control process.

### <Flow for Autonomous Parking>

Now, an example of an overall flow for the autonomous parking will be described using FIG. 5. In FIG. 5, HV refers to the host vehicle. PS in FIG. 5 refers to the parking space. TPP in FIG. 5 refers to the target parking position. A, B, C, and D in FIG. 5 refers to step of the autonomous parking.

As shown in FIG. 5, when the host vehicle is in a stopped state in the vicinity of a parking section for example, the autonomous parking starts. For example, the stopped state of the host vehicle may be due to a manual operation by the occupant of the host vehicle. Specifically, the stopped state may be due to a braking operation by the occupant of the host vehicle. The stopped state may be due to the autonomous driving by the system. Upon the autonomous parking starting, the host vehicle HV is moved forward for vehicle position orientation adjustment (see FIG. 5 for A). In the vehicle position orientation adjustment, the host vehicle HV is moved forward while turning to attain a vehicle position orientation that allows the vehicle to move into the parking space PS in reverse motion. Then, the host vehicle HV is move into the parking space PS in reverse motion (see B in FIG. 5). Then, the vehicle is moved forward to make a turnaround for aligning the host vehicle position with the target parking position TPP (see FIG. 5 for C). Finally, the host vehicle HV is moved in reverse to align the host vehicle position with the target parking position TPP (see FIG. 5 for D).

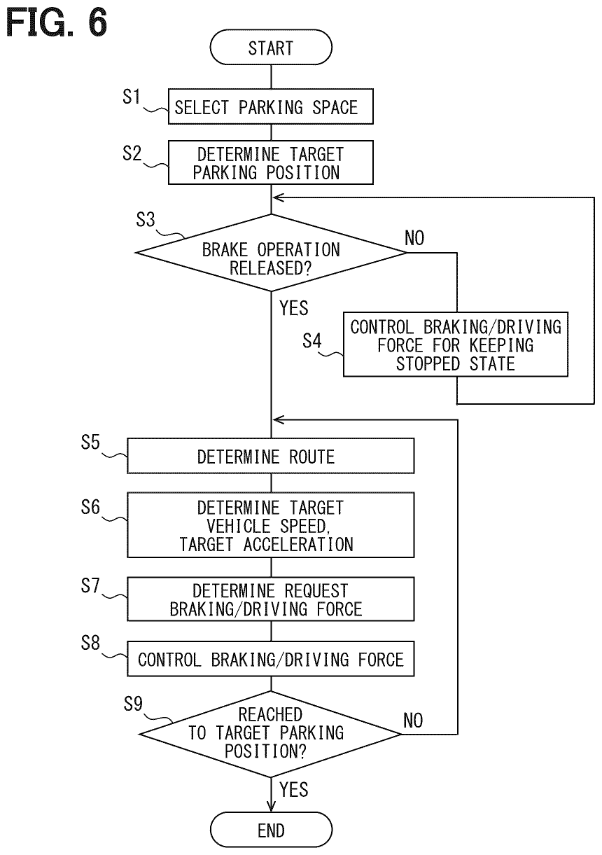

Using the flowchart in FIG. 6, an example flow of the control by the driver assist ECU 10 during the autonomous parking will be described. FIG. 6 illustrates an example case where a brake operation by the occupant is required to maintain the stopped state before starting. The flowchart in FIG. 6 starts upon, for example, turn ON of the AP switch when the host vehicle is in the stopped state in the vicinity of a parking section. For describe purpose, description of steering control is omitted, and the braking/driving force control will be described.

First, in step S1, the parking position determination unit 102 accepts selection of a parking space in which the host vehicle is to be parked. The parking position determination unit 102 may determine the parking space according to the input received from the occupant at the user input device 17. As an example, the system may be configured to allow the occupant to select a parking space from the candidate parking spaces displayed on the display unit of the host vehicle. In step S2, the parking position determination unit 102 determines the parking space selected in S1 as being the target parking position.

In step S3, if the brake operation by the occupant is released (YES in S3), the process proceeds to step S5. If the brake operation by the occupant is not released (NO in S3), the system proceeds to step S4. The driver assist ECU 10 may determine whether the brake operation is released or not, based on the sensing information of the brake sensor. For example, a brake operation release timing may be treated as timing to start control of the host vehicle starting.

In step S4, the braking driving control unit 104 executes the braking/driving force control for maintaining the vehicle stopped state. Then, the process returns to step S3. In the braking/driving force control for maintaining the vehicle stopped state, when the brake operation by the occupant alone is insufficient to maintaining the vehicle stopped state, the braking driving control unit 104 generates the braking/driving force corresponding to the insufficiency. In other words, when the braking force requested by the brake operation of the occupant alone is insufficient to maintaining the vehicle stopped state, the braking/driving force is generated for compensating the insufficiency.

In step S5, the route determination unit 103 determines the route for traveling to the target parking position determined in S2 under the autonomous parking. The route determination unit 103 may successively re-determine the target path to adapt to changing situations. In step S6, the braking driving control unit 104 determines the target vehicle speed and target acceleration for moving the host vehicle along the route determined in S5. In step S7, the braking driving control unit 104 determines the request braking/driving force for attaining the target vehicle speed and the target acceleration determined in S6.

In step S8, the braking driving control unit 104 executes control so that the request braking/driving force determined in S7 is generated. In step S9, if the host vehicle has reached the target parking position (YES in S9), the flow ends. If the host vehicle has not reached the target parking position (NO in S9), the process returns to S5 and repeats.

### <During-Traveling Process in Braking Driving Control Unit 104>

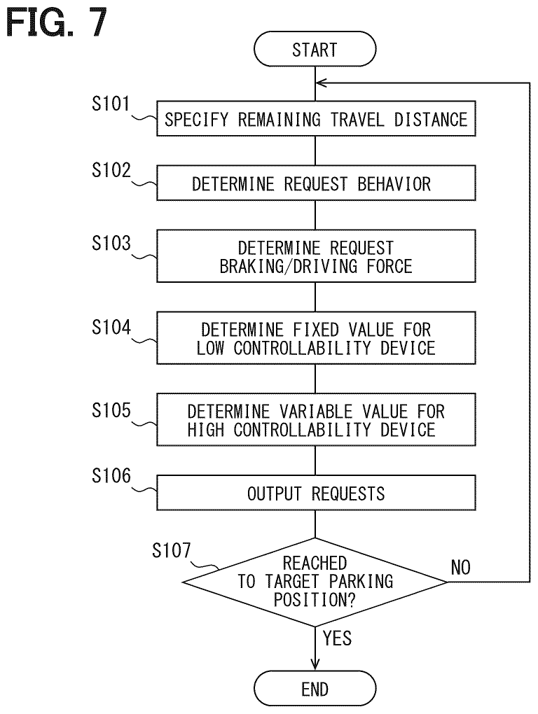

Using the flowchart in FIG. 7, an example flow of the during-traveling process in the braking driving control unit 104 will be described. FIG. 7 illustrates an example case where the host vehicle executes the autonomous parking. The flowchart in FIG. 7 starts upon, for example, the host vehicle starting. Based on detecting the vehicle speed greater than zero by the vehicle speed sensor for example, the starting of the host vehicle may be determined by the braking driving control unit 104.

First, in step S101, the required braking/driving force determination unit 144 specifies the distance from the host vehicle position to the target parking position (hereinafter referred to as “remaining travel distance”). The required braking/driving force determination unit 144 may specify the remaining travel distance on the route determined by the route determination unit 103.

In step S102, the required braking/driving force determination unit 144 determines the request behavior for traveling the remaining travel distance. As an example, the required braking/driving force determination unit 144 may determine a maximum vehicle speed, a maximum acceleration, a maximum jerk, a minimum acceleration, and a minimum jerk, depending on the remaining travel distance. Based on these values, the required braking/driving force determination unit 144 may determine the request behavior such as a request vehicle speed, a request acceleration, and a request jerk, etc.

In step S103, the required braking/driving force determination unit 144 determines the required braking/driving force. The required braking/driving force determination unit 144 determines the required braking/driving force required to travel the remaining distance, based on the behavior specified in S102. The required braking/driving force determination unit 144 may determine the required braking/driving force so as to reduce the deviation of the actual behavior from the previously requested behavior.

In step S104, the allocation determination unit 145 determines the fixed value of the braking/driving force allocated to the low controllability device. The allocation determination unit 145 determines this fixed value in a way described above. In step S105, the allocation determination unit 145 determines the variable value of the braking/driving force allocated to the high controllability device. In S105, of the braking/driving force determined in S103, part attained by other than the fixed value determined in S104 may be determined as being the braking/driving force allocated to the high controllability device.

In step S106, a request to output the braking/driving force determined in S104 is issued to the low controllability device and a request to output the braking/driving force determined in S105 is issued to the high controllability device. If it is determined in step S107 that the host vehicle has reached the target parking position (YES in S107), the flow ends. If the host vehicle has not reached the target parking position (NO in S107), the process returns to S101 and repeats.

### <Change in Braking/Driving Force During Traveling Under Control of Braking Driving Control Unit 104>

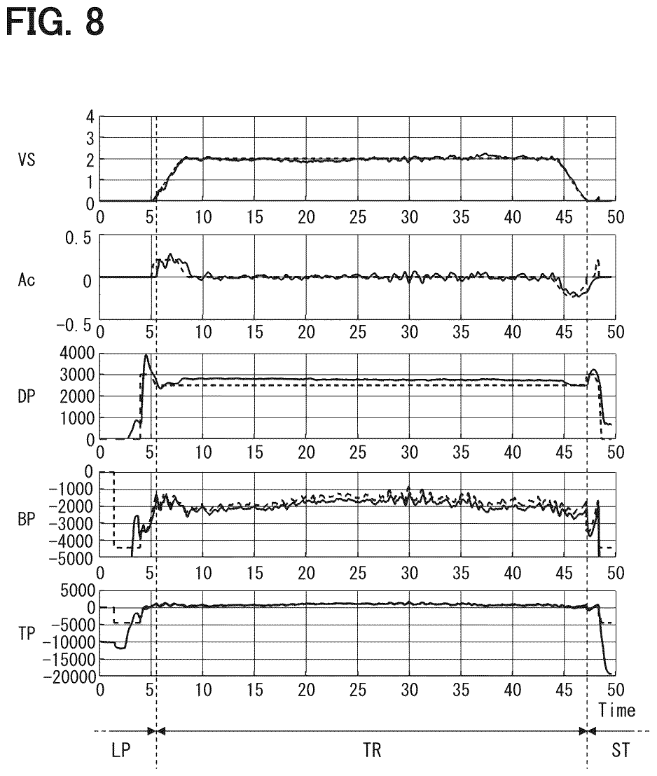

Using the graph in FIG. 8, a change in the braking/driving force during the traveling after starting due to the control of the braking driving control unit 104 will be described. FIG. 8 illustrates an example case in which the driving device is the low controllability device and the brake device is the high controllability device. In the graph in FIG. 8, the horizontal axis is time. VS in FIG. 8 shows a change in the vehicle speed of the host vehicle over time. Ac in FIG. 8 shows a change in the acceleration of the host vehicle over time. DP in FIG. 8 shows a change in the driving force of the host vehicle over time. BP in FIG. 8 shows a change in the braking force of the host vehicle over time. TP in FIG. 8 shows a change in a total value over time, where the total value is a value obtained by adding together the driving force and the braking force of the host vehicle. The solid line in FIG. 8 shows the actual value and the dashed line shows the request value. The DP in FIG. 8 shows a time period before starting. TR in FIG. 8 shows a time period of traveling from starting to stopping. The change in the braking/driving force during this traveling time period will be described. The vehicle is assumed to travel at a constant speed. ST in FIG. 8 indicates the time period after making the stop.

As shown in FIG. 8, during traveling, the driving force requested for the driving device being the low controllability device is maintained at the fixed value. Therefore, the driving force output from the driving device during traveling is also maintained approximately at the fixed value. In contrast, during traveling, the braking force requested for the brake device being the high controllability device changes in accordance with the request braking/driving force. Therefore, the driving force output from the brake device during traveling also changes. If the driving device is the high controllability device and the brake device is the low controllability device, a relationship opposite to that described above happens.

For stopping the vehicle in an emergency, the braking driving control unit 104 may request both the driving device and the brake device for the braking/driving force for stopping the vehicle. In another case, during traveling in a transition interval, control may be executed differently than during traveling at the constant speed, wherein the transition interval is an interval between starting and constant speed traveling. The transition interval may be set by the braking driving control unit 104 based on a sensory index for acceleration, the driving force speed and the braking force speed. The sensory index stored in the non-volatile memory of the driver assist ECU 10 may be used. The request value of the braking/driving force for the low controllability device in the transition interval may be determined so as to change linearly from the request value before the starting to the request value for the constant speed traveling. Because of this, discomfort feeling of the occupant due to sudden change in the braking/driving force is further reducible.

### Second Embodiment

The first embodiment illustrates that the driver assist ECU 10 recognizes the traveling environment of the host vehicle by way example. The present disclosure is not limited to this. For example, a system may be configured such that an ECU other than the driver assist ECU 10 recognizes the traveling environment of the host vehicle. In this case, the driver assist ECU 10 may be configured to acquire information on the traveling environment recognized by the ECU other than the driver assist ECU 10.

### Third Embodiment

The first embodiment illustrates the control of the braking/driving force during while the vehicle is traveling under the autonomous parking the after starting. The present disclosure is not limited to this. For example, without limiting the autonomous traveling control after starting to the autonomous parking, the control of the braking/driving force during the vehicle traveling under the autonomous traveling control may executed in a similar way. The remaining travel distance used in this case may be a distance along the route determined by the route determination unit 103 from the host vehicle position to the destination in the autonomous traveling control. The route determination unit 103 may be configured to determine the route to the set destination. The destination may be a via-point in the route to the final destination.

### Disclosure of Technical Ideas

The below listed technical ideas are part of the present disclosure.

### Technical Idea 1

A vehicular control device usable for a vehicle that executes autonomous traveling control incudes:
a braking/driving force control unit that controls a driving force generated from a driving device of the vehicle and a braking force generated from a brake device of the vehicle;
a performance information acquisition unit that acquires performance information on performance of the vehicle, including:
driving accuracy, which is accuracy achieved by the driving device in response to a force request;
braking accuracy, which is accuracy achieved by the brake device in response to a force request;
a driving force range, which is a range of the driving force that the driving device is able to reflect the force request in with specified accuracy or accuracy higher than the specified accuracy;
a braking force range, which is a range of the braking force that the brake device is able to reflect the force request in with specified accuracy or accuracy higher than the specified accuracy; and
a request minimum value, which is a minimum value of the driving force requestable to the driving device and depends on speed of the vehicle;
a request range determination unit that, by using the performance information acquired by the performance information acquisition unit, determines a driving system request range and a brake system request range, wherein the driving system request range is a range of request value estimated to guarantee the specified accuracy of the driving device and the brake system request range is a range of request value estimated to guarantee the specified accuracy of the brake device;
a required braking/driving force determination unit that determines a braking/driving force required for traveling planned by the autonomous traveling control when the vehicle is traveling under the autonomous traveling control, wherein the braking/driving force is at least one of the driving force or the braking force;
a controllability determination unit that determines a high controllability device and a low controllability device from among the driving device and the brake device, wherein the high controllability device is a device that performs control with higher accuracy and the low controllability device is a device that performs control with lower accuracy; and
an allocation determination unit that determines allocation of the braking/driving force determined by the required braking/driving force determination unit to the driving device and the brake device to determine values of the braking/driving force allocated to the driving device and the brake device, such that: the braking/driving force allocated to the low controllability device is a fixed value within the range of request value determined by the request range determination unit; and, of the braking/driving force determined by the request driving force determination unit, a part attained by other than the fixed value is a value within the range of request value for the high controllability device determined by the request range determination unit, wherein:
when the vehicle is traveling, the braking/driving force control unit controls the driving force and the braking force so that the driving force generated from the driving device and the braking force generated from the brake device match the values determined by the allocation determination unit.

### Technical Idea 2

In the vehicular control device according to technical idea 1:
the required braking/driving force determination unit successively determines the braking/driving force to reduce deviation of actual behavior from behavior requested for the traveling planned by the autonomous traveling control.

### Technical Idea 3

In the vehicular control device according to technical idea 1 or 2:
the allocation determination unit determines that a value closest to zero among values that meet a specific condition is the fixed value for the low controllability device, wherein the specific condition is that each of the values allocated to the high controllability device and the low controllability device is within the range of request value determined by the request range determination unit.

### Technical Idea 4

In the vehicular control device according to any one of technical ideas 1 to 3:
the driving force range acquired by the performance information acquisition unit is the range of the driving force that the driving device is able to reflect the force request in with the specified accuracy or accuracy higher than the specified accuracy in respect of both static and dynamic characteristics; and
the braking force range acquired by the performance information acquisition unit is the range of the braking force that the brake device is able to reflect the force request in with the specified accuracy or accuracy higher than the specified accuracy in respect of both static and dynamic characteristics.

### Technical Idea 5

In the vehicular control device according to any one of technical ideas 1 to 4:
by using the driving system request range and the brake system request range determined by the request range determination unit, the controllability determination unit determines the high controllability device and the low controllability device such that: when the driving system request range is wider than the brake system request range, the driving device is the high controllability device and the brake device is the low controllability device; and when the driving system request range is narrower than the brake system request range, the driving device is the low controllability device and the brake device is the high controllability device.

### Technical Idea 6

In the vehicular control device according to any one of technical ideas 1 to 5:
the vehicular control device is usable for the vehicle that executes the autonomous traveling control for autonomous parking; and
the braking/driving force control unit controls the braking force and the driving force so that the braking force generated from the brake device and the driving force generated from the driving device match the values determined by the allocation determination unit during traveling after starting in the autonomous parking.

The present disclosure is not limited to the embodiments described above and can be modified in various ways within the spirit and scope of the present disclosure. An embodiment obtained by appropriately combining technical features disclosed in different embodiments may also be included in the present disclosure. Control units and methods thereof described in the present disclosure may be implemented by a special purpose computer provided by configuring a processor programmed to execute one or more functions embodied by a computer program. Alternatively, control units and methods thereof described in the present disclosure may be implemented by a dedicated hardware logic circuit. Alternatively, control units and methods thereof described in the present disclosure may be implemented by one or more special purpose computer provided by configuring a processor executing a computer program in combination with one or more hardware logic circuits. The computer program may be stored on a computer-readable non-transitory tangible storage medium as instructions executed by a computer.

What is claimed is:

1. A vehicular control device that is usable for a vehicle that executes autonomous traveling control, comprising:
at least one processor that executes a program and/or at least one dedicated circuit, configured to:
in a braking/driving force control process, control a driving force generated from a driving device of the vehicle and a braking force generated from a brake device of the vehicle;
in a performance information acquisition process, acquire performance information on performance of the vehicle, including:
driving accuracy, which is accuracy achieved by the driving device in response to a force request;
braking accuracy, which is accuracy achieved by the brake device in response to a force request;
a driving force range, which is a range of the driving force that the driving device is able to reflect the force request in with specified accuracy or accuracy higher than the specified accuracy;
a braking force range, which is a range of the braking force that the brake device is able to reflect the force request in with specified accuracy or accuracy higher than the specified accuracy; and
a request minimum value, which is a minimum value of the driving force requestable to the driving device and depends on speed of the vehicle;
in a request range determination process, determine a driving system request range and a brake system request range by using the acquired performance information, wherein the driving system request range is a range of request value estimated to guarantee the specified accuracy of the driving device and the brake system request range is a range of request value estimated to guarantee the specified accuracy of the brake device;
in a required braking/driving force determination process, determine a braking/driving force required for traveling planned by the autonomous traveling control when the vehicle is traveling under the autonomous traveling control, wherein the braking/driving force is at least one of the driving force or the braking force;
in a controllability determination process, determine a high controllability device and a low controllability device from among the driving device and the brake device, wherein the high controllability device is a device that performs control with higher accuracy and the low controllability device is a device that performs control with lower accuracy; and
in an allocation determination process, determine allocation of the braking/driving force determined in the required braking/driving force determination process to the driving device and the brake device to determine values of the braking/driving force allocated to the driving device and the brake device, such that: the braking/driving force allocated to the low controllability device is a fixed value within the range of request value determined in the request range determination process; and, of the braking/driving force determined in the required braking/driving force determination process, a part attained by other than the fixed value is a value within the range of request value for the high controllability device determined in the request range determination process, wherein:
the at least one processor and/or the at least one dedicated circuit is configured to:
in the braking/driving force control process, control the driving force and the braking force when the vehicle is traveling so that the driving force generated from the driving device and the braking force generated from the brake device match the values determined in the allocation determination process.

2. The vehicular control device according to claim 1, wherein:
the at least one processor and/or the at least one dedicated circuit is configured to:
in the required braking/driving force determination process, successively determine the braking/driving force to reduce deviation of actual behavior from behavior requested for the traveling planned by the autonomous traveling control.

3. The vehicular control device according to claim 1, wherein:
the at least one processor and/or the at least one dedicated circuit is configured to:
in the allocation determination process, determine that a value closest to zero among values that meet a specific condition is the fixed value for the low controllability device, wherein the specific condition is that each of the values allocated to the high controllability device and the low controllability device is within the range of request value determined in the request range determination process.

4. The vehicular control device according to claim 1, wherein:
the driving force range acquired in the performance information acquisition process is the range of the driving force that the driving device is able to reflect the force request in with the specified accuracy or accuracy higher than the specified accuracy in respect of both static and dynamic characteristics; and
the braking force range acquired in the performance information acquisition process is the range of the braking force that the brake device is able to reflect the force request in with the specified accuracy or accuracy higher than the specified accuracy in respect of both static and dynamic characteristics.

5. The vehicular control device according to claim 1, wherein:
the at least one processor and/or the at least one dedicated circuit is configured to:
in the controllability determination process, determine the high controllability device and the low controllability device by using the driving system request range and the brake system request range determined in the request range determination process, such that: when the driving system request range is wider than the brake system request range, the driving device is the high controllability device and the brake device is the low controllability device; and when the driving system request range is narrower than the brake system request range, the driving device is the low controllability device and the brake device is the high controllability device.

6. The vehicular control device according to claim 1, wherein:
the vehicular control device is usable for the vehicle that executes the autonomous traveling control for autonomous parking; and
the at least one processor and/or the at least one dedicated circuit is configured to:
in the braking/driving force control process, control the braking force and the driving force so that the braking force generated from the brake device and the driving force generated from the driving device match the values determined in the allocation determination process during traveling after starting in the autonomous parking.

7. A vehicular control method executed by at least one processor and usable for a vehicle that executes autonomous traveling control, the vehicular control method comprising:
in a braking/driving force control process, controlling a driving force generated from a driving device of the vehicle and a braking force generated from a brake device of the vehicle;
in a performance information acquisition process, acquiring performance information on performance of the vehicle, including:
driving accuracy, which is accuracy achieved by the driving device in response to a force request;
braking accuracy, which is accuracy achieved by the brake device in response to a force request;
a driving force range, which is a range of the driving force that the driving device is able to reflect the force request in with specified accuracy or accuracy higher than the specified accuracy;
a braking force range, which is a range of the braking force that the brake device is able to reflect the force request in with specified accuracy or accuracy higher than the specified accuracy; and
a request minimum value, which is a minimum value of the driving force requestable to the driving device and depends on speed of the vehicle;
in a request range determination process, determining a driving system request range and a brake system request range by using the acquired performance information, wherein the driving system request range is a range of request value estimated to guarantee the specified accuracy of the driving device and the brake system request range is a range of request value estimated to guarantee the specified accuracy of the brake device;
in a required braking/driving force determination process, determining a braking/driving force required for traveling planned by the autonomous traveling control when the vehicle is traveling under the autonomous traveling control, wherein the braking/driving force is at least one of the driving force or the braking force;
in a controllability determination process, determining a high controllability device and a low controllability device from among the driving device and the brake device, wherein the high controllability device is a device that performs control with higher accuracy and the low controllability device is a device that performs control with lower accuracy; and
in an allocation determination process, determining allocation of the determined braking/driving force to the driving device and the brake device to determine values of the braking/driving force allocated to the driving device and the brake device, such that: the braking/driving force allocated to the low controllability device is a fixed value within the range of request value determined in the request range determination process; and, of the braking/driving force determined in the required braking/driving force determination process, a part attained by other than the fixed value is a value within the range of request value for the high controllability device determined in the request range determination process, wherein:
when the vehicle is traveling, the braking/driving force control process controls the driving force and the braking force so that the driving force generated from the driving device and the braking force generated from the brake device match the values determined in the allocation determination process.
